(19) United States
(12) Patent Application Publication
(10) Pub. No.: US 2024/0354010 A1
(43) Pub. Date: Oct. 24, 2024

(54) METHOD FOR CONTROLLING ACCESS TO A DISK DEVICE CONNECTED TO AN EXECUTION PLATFORM AND EXECUTION PLATFORM FOR CONTROLLING AN ACCESS TO A DISK DEVICE

(71) Applicant: THALES DIS CPL USA, INC., AUSTIN, TX (US)

(72) Inventors: Rajesh GUPTA, San Jose, CA (US); Peter SCOTT, Boulder, CO (US); Jeff BROMBERGER, Springfield, MO (US); Rohan NANDODE, Pune (IN)

(73) Assignee: THALES DIS CPL USA, INC., AUSTIN, TX (US)

(21) Appl. No.: 18/686,533

(22) PCT Filed: Aug. 26, 2022
(86) PCT No.: PCT/US2022/041616

§ 371 Date: Feb. 26, 2024

(30) Foreign Application Priority Data
Aug. 27, 2021 (US) 63/237613

(51) Int. Cl. G06F 3/06

(52) U.S. Cl. CPC G06F 3/0622; G06F 3/0655; G06F 3/067

(57) ABSTRACT

A method for controlling access to a disk device connected to an execution platform that includes reserving a first region of the disk device and storing an unique disk label in said first region, wherein said first region is not encrypted, encrypting a second region of the disk device, wherein the second region includes user data and file information, said method further comprises providing a cipher agent running on said execution platform and carrying out the following steps in case an opening of the disk device is requested, reading the unique disk label stored in the first region, retrieving a protection policy for the disk device based on the unique disk label and handling the further access to the disk device based on the protection policy.

### FIELD OF USE

The present invention relates to a method for controlling access to a disk device connected to an execution platform and to an execution platform for controlling access to a disk device.

### BACKGROUND

On Windows systems there are no identifiers for hard disk devices or logical unit numbers which are unique or easy for human interaction. There is a device path like \device\00000011 but it is not unique or persistent across reboots or systems. The device path may change for the same disk on a system reboot or the disk is attached to another system.

There is a serial number for each disk device of the form “B23BD65F” which is relatively unique for the device and persistent across reboot and multiple systems. But it is difficult to remember or comprehend for user.

A disk usually has a partition table and its related information along with actual volumes to store user data. On Windows systems there is a private system volume partition reserved by the system. Many of disk encryption solutions only encrypt user volumes while skipping the partition information as is.

An encrypted device can be accessed in multiple ways either by the system or the user applications. Because the encryption is at the disk device level, any application which can directly open the volume or disk will be able to read or modify the clear data. File system level checks alone cannot block these types of access because the storage system is layered. Therefore, for example, the file system is at the top, then the volume, then the disk. A request that starts at the file system level will generally go down to the lower layers (i.e. the data will actually be read from the volume/disk) but a request which starts at the volume/disk (block) level will never go the other way up to the file system. So if the file system rules say “block this user from reading file X” but that user opens the disk directly and reads the region of storage where that file resides, then he has completely bypassed any protections in the file system by skipping that layer altogether.

### SUMMARY

Therefore, there is a need to provide a method for controlling an access to a disk device connected to an execution platform which provides a better protection against on authorized use.

The invention is defined by the independent claims 1 and 9. Further developments of the invention are given in the dependent claims.

A method for controlling access to a disk device connected to an execution platform can comprise the steps of:

reserving a first region of the disk device and storing an unique disk label in said first region, wherein said first region is not encrypted, and

encrypting a second region of the disk device, wherein the second region includes user data and file information.

Said method can further comprises providing a cipher agent running on said execution platform and carrying out the following steps in case an opening of the disk device is requested,
reading the unique disk label stored in the first region,
retrieving a protection policy for the disk device based on the unique disk label and
handling the further access to the disk device based on the protection policy.

In view of the unique disk label stored in the first region of the disk device it is possible to identify the disk device uniquely across system reboots, multiple host systems and cluster nodes. Therefore, the cipher agent can retrieve the corresponding protection policy for the disk device and can handle the further access to the disk device based on the protection policy.

The inventive method can address the use case of protecting the disk devices from unauthorized access by processes during ransomware attacks. In particular, a protection of the disk device can be provided by using access control and encryption.

The cipher agent can be software or a software module running on the execution platform.

The execution platform for controlling an access to a disk device can comprise the same features as the inventive method for controlling an access to a disk device connected to an execution platform (including all further embodiment of the inventive method).

It goes without saying that the features mentioned above and so yet to be explained below are usable not only in the combinations specified but also in other combinations or on their own, without departing from the scope of the present invention.

In the following text, the invention is explained in more detail on the basis of exemplary embodiments with the reference to the appended drawings, which likewise disclose features which are essential to the invention. These exemplary embodiments serve merely for illustration and should not be interpreted as limiting. For example, the description of an embodiment having a large number of elements or components should not be interpreted as meaning that all of these elements or components are necessary for implementation. Rather, other embodiments can also contain alternative elements and components, further elements or components, or additional elements or components. Elements or components of different embodiments can be combined with one another, unless specified otherwise. Modifications and alterations that are described for one of the embodiments can also be applicable to other embodiments. In order to avoid repetitions, identical or mutually corresponding elements in different figures are provided with the same reference signs and not explained several times. In the figures:

### BRIEF DESCRIPTION OF THE DRAWINGS

FIG. 1 schematically shows an execution platform together with a connected disk device;

FIG. 2 schematically shows the functionality of the cipher agent for handling access to the disk device; and

FIG. 3 schematically shows the functionality of the cipher agent for handling access to the disk device.

### DETAILED DESCRIPTION

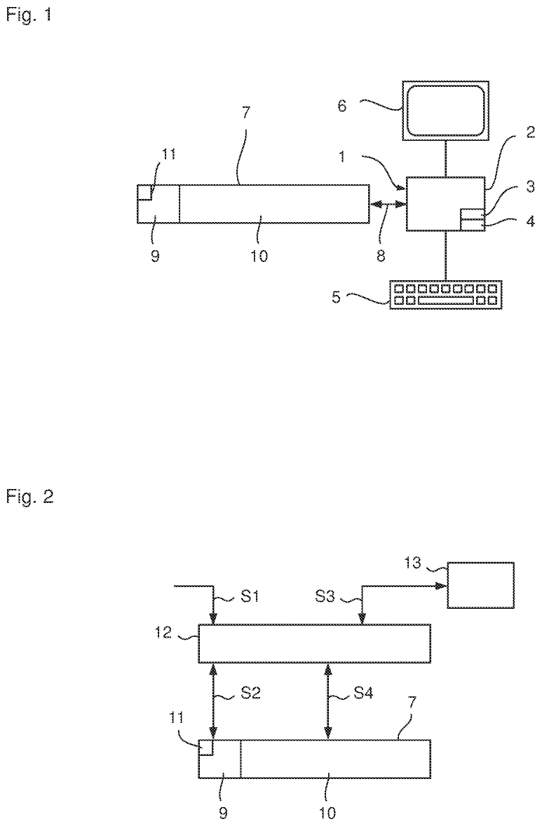

FIG. 1 schematically shows an execution platform 1 for executing software applications. The execution platform 1 is embodied as a conventional personal computer, for example, comprising a computing section 2 (including, e.g., a processor 3, working memory 4, an operating system and further hardware elements), an input unit 5 (in this case, for example, a keyboard) as well as an output unit 6 (e.g. a screen). Of course, the execution platform can be a distributed system (in which components of the distributed system are located on different networked computers), a multiple host system or computer cluster, for example.

Further, there is provided a disk device 7 to be connected to the execution platform 1 as indicated with the two-headed arrow 8. The disk device 7 can be a hard disk drive (using magnetic storage or embodied as a solid-state drive for example). Further, the disk device 7 can be embodied in different form factors (e.g. as 3.5 inch or 2.5 inch drive or as a USB flash drive). In particular, the disk device 7 can be an external mass storage device or can be provided by an external mass storage device (e.g. SAN (storage area network) and/or NAS (network attached storage)). Thus, the disk device 7 can be a directly attached disk device, a disk in a RAID configuration (RAID=Redundant Array of Independent Disks) attached to a controller on execution platform 1 or an external SAN/NAS storage device.

As indicated, the disk device 7 comprises a first region 9 and a second region 10.

For identifying the disk device 7 uniquely across reboots and/or across different execution platforms a unique disk label 11 is associated with the disk device 7 and stored in the first region 9 on the same disk device 7. This unique disk label 11 is preferably provided by user, so he/she can easily comprehend and remember it. Even if the disk device 7 is moved to another system or another execution platform, the disk device 7 can be identified by the exact same disk label 11. By storing the unique disk label 11 on the disk device 7, there is provided an independency of any operating system details. For example, if a normal disk is inserted into the execution platform 1 it might be known as \Device\00000005. If said normal disk is put into a different system it might be \Device\00000007, or if the operation system is different it could even be something like/dev/sd1. There would be no way to know for sure that this is the same disk. However, according to the invention there can be added a private region (said first region 9) on the disk device 7 which contains a user defined unique disk label 11 (e.g. “SQL Database 123”), now no matter where the disk device 7 is moved, and no matter what order the operation system attaches the disks, the user can always know that this is the same disk he thinks it is.

The first region 9 is not encrypted and can comprise 64 MB. There can be further information stored in the first region, as for example key information which are used for encrypting/decrypting the second region 10. Of course, the size of the first region 9 can vary and need not be always 64 MB.

The second region 10 can comprise 100 GB and includes the user data as well as the file information (e.g. a partition table and other system specific private volumes). Of course, the size of the second region 10 can vary and need not be always 100 GB.

There is further provided a cipher agent 12 (FIG. 2) running on the execution platform 1. In case an opening of a disk device 7 is requested (FIG. 2; step S1) the cipher agent 12 can carry out the following steps. The disk device 7 is identified and the unique disk label 11 is read from the first region 9 (step S2). Thereafter, the cipher agent 12 retrieves a protection policy for said disk device 7 based on the unique disk label 11 from a data security manager 13 (step S3).

Generically speaking a protection policy will contain user sets, resource sets and rule sets. For example, it will establish that “Bob” is able to read all files but not write to any of them, “Alice” is able to read and write all files, and “Carl” can read all *.pdf files but only getting the ciphertext (e.g. for backup purposes).

The data security manager 13 is not part of the execution platform 1 but part of a remote system which can be accessed via internet, for example. Thus, the security can be enhanced, since all the pieces of the puzzles are not stored on the same platform. In particular, the data security manger 13 should be thought of as a separate system, a black box, which provides policy information to different execution platforms 1 running the cipher agent 7 software. It is a centralized authority which pushes configuration and key information to all the individual execution platforms 1.

The cipher agent 12 handles the further access to the disk device 7 based on the protection policy (step S4). Step S4 enforces the policy such that, for example, the whitelist in the policy is checked, the process signatures (preferably the signatures are stored on the data security manager 13 and the security is brought to execution platform so that any malicious application can't update them and break the protection) are validated and as a result the application is allowed or disallowed to open the disk device 7. In case it is allowed to open the disk device 7 such an access includes the necessary decryption for reading data from the second region 10 and encryption for storing data in the second region 10 (it is also possible that that the policy indicates that disk device 7 can be opened but no encryption or decryption is allowed). In this way, the protection policy on the user data is enforced and the disk device 7 is protected.

As discussed, the first region 9 is part of the disk space provided by the disk device 7. Therefore, a certain space or a few sectors are reserved on the disk device 7. These reserved sectors need to be protected from other components so that they do not overwrite it. Also, since these reserved sectors cannot be used by the execution platform 1, the reported device size need to be reduced.

On windows systems any implementation above disk layer are prone to issues and not always reliable.

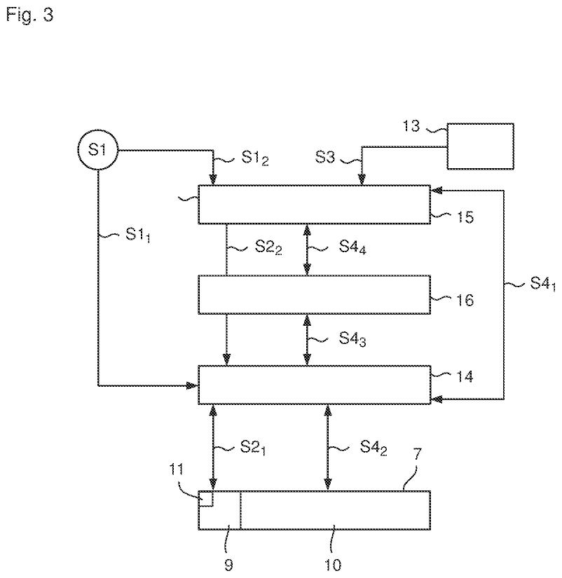

Hence, the cipher agent 12 comprises a cipher disk driver 14 below the disk layer of the operation system (and therefore below the disk system driver 16 of the Windows operation system) as show in FIG. 3 (above/below are key properties as the relative position in the stack determines the order of the processing). Thus, the cipher disk driver 14 is a kernel driver below the disk system driver 16 and is capable of filtering SCSI (SCSI =Small Computer System Interface) requests (steps S1, S1₁, S2₁). In addition, the cipher disk driver 14 reduces the reported disk size of the disk device 7 by the amount of the first region. In the present example, the disk space of the disk device 7 is 100.064 GB. Since 64 MB are reserved for the first region 9 the reported disk size is 100 GB. By providing the cipher disk driver 16 it is possible to capture SCSI device paths and handle the access according to the protection policy described above (steps S3, S4₁, S4₂).

In addition to these two functions, the cipher disk driver 14 also needs to adjust the disk offsets of all operations. For example, if first region 9 is 64 MB in length then the data located at offset 64 MB on the physical disk is actually the logical offset 0 of the user data. Therefore, if a user application reads data at offset 1 MB, it must be translated by adding 64 MB to the offset and produce a physical disk read at offset 65 MB.

Thus, the first region 9 is hidden and the operation system and/or user is made to believe that the disk device 7 is slightly smaller. As a result, as already described, the cipher agent 12 and in particular the cipher disk driver 14 translates any operation which reference specific disk offsets because the logical/effective offset will differ from the physical/actual offset.

Since the cipher disk driver 14 is a kernel driver below the disk system driver 16 the advantage is achieved, that a potential bypass can be avoided. This is because one is more sensitive to the order of layering above the disk layer. At each layer (file system, volume, etc) there can be many drivers providing functionality at that level. But because it is needed to translate locations it must be guaranteed to also be the last component in the sequence. Otherwise, just like the example above with completely bypassing the file system, a user could potentially bypass the inventive execution platform 1. For example, if the cipher disk driver 14 were a volume filter, what happens if the user does a read directly at the disk level? The inventive execution platform 1 won't see it and, thus, it can't be adjusted, and then the user gets the wrong data, sees our private region, etc.

Further, it is possible, that the disk device 7 is accessed as a volume path (e.g. \\.\C: ) or as a raw disk device path (e.g. \\.\PhysicalDrive1), and therefore through the file system layer. For this case, the cipher agent 12 comprises the cipher file system driver 15 to filter such paths (steps S1, S1₂, S2₂ and S2₁) and handle the access according to the protection policy as mentioned above (steps S3, S4₁, S4₂, S4₃, S4₄).

Therefore, the inventive method identifies and associates different paths to the encrypted disk device 7 and protects an access through these paths according to the corresponding protection policy.

Therefore, it is possible to stop both internal and external threats to the data by protecting the disk device 7. In case the disk device 7 itself provides encryption/decryption any direct disk or volume reads from applications would get clear data. The inventive method prevents this by blocking direct disk and volume reads from any applications which are not authorized/whitelisted. Further, the inventive method cannot not only used to protect date, but can also prevent any malicious application to destroy or delete the device. If any unauthorized application tries to delete, corrupt or update the critical data on the disk device 7, it will be prevented. Therefore, it is possible to provide a more enhanced, efficient and stronger protection on external disk devices 7.

In case of file system level encryption direct disk or volume level reads are not a big concern since they will return encrypted data. But, ransomware can still perform direct disk or volume writes which will cause data loss. Such a data loss can be very expensive for companies. With the inventive method such a data loss will be prevented as ransomware would not be an authorized/whitelisted application and therefore could not access the disk device 7 directly.

The unique disk label 11 can be chosen by a user. In particular a user can specify unique human readable name and define which applications are allowed to access the disk device 7. For example, the user signs the applications to be allowed (including system process), create a process set and add process signature, and add process set in the protection policy. User can compile the data protection, access control and devise protection policies and associate these policies with the unique disk label 11 to provide protection. Therefore, user does not have to remember long serial numbers, device IDs and hardware IDs to apply the policies and protection.

Further, in view of the unique disk label 11 it is possible to identify the disk device 7 uniquely across system reboots, multiple host systems and cluster nodes. When the disk device 7 is moved from one system to another system, the unique disk label 11 will identify the protected disk device 7 and enable the protection.

Further, it is possible, that the user can specify the whitelisted applications that can access the disk device 7. Hence prohibiting any user or administrator to install unauthorized or unverified applications to access the protected data. This innovation identifies the various way to access/open the disk device 7 directly and ensures only whitelisted application can access the disk device 7.

Customers can protect their disk devices from rogue administrators, who can directly open the disk device and read or corrupt the data. This enhanced protection provides data security and device protection from privilege users.

According to the present invention, the first region 9 of the disk device 7 is a dedicated private storage which only can be accessed as described above. Even if a user (or operation system) attempts to read from “the beginning” of the disk device 7, they will actually be reading from the beginning of the second region 10. In particular, drivers (e.g. the cipher disk driver 14 and the cipher file system driver 15) will translate all requests to effectively hide the first region 9 and make the operating system believe that the entire disk device 7 is simply the second region 10.

1. Method for controlling access to a disk device connected to an execution platform,
the method comprising
reserving a first region of the disk device and storing an unique disk label in said first region, wherein said first region is not encrypted, encrypting a second region of the disk device, wherein the second region includes user data and file information,
said method further comprises providing a cipher agent running on said execution platform and carrying out the following steps in case an opening of the disk device is requested,
reading the unique disk label stored in the first region,
retrieving a protection policy for the disk device based on the unique disk label and
handling the further access to the disk device based on the protection policy.

2. Method according to claim 1,
wherein the cipher agent carries out decryption for reading data from the second region and encryption for writing data in the second region.

3. Method according to claim 1,
wherein the cipher agent comprises a cipher disk driver below the disk layer of an operating system running on the execution platform,
said cipher disk driver controls access to the disk device which bypasses the disk layer.

4. Method according to claim 1,
wherein the cipher agent comprises a file system driver for controlling access to the disk device through a disk layer of an operating system running on the execution platform.

5. Method according to claim 1,
wherein the protection policy comprises a whitelist of applications allowed to access the disk device,
wherein the cipher agent does only allow access to the disk device by an application included in the whitelist.

6. Method according to claim 1, further comprising a data security manager for handling the security policy and for ensuring that the disk label is a unique disk label.

7. Method according to claim 1, comprising a label step in which a user can be define the unique disk label.

8. Method according to claim 1, comprising a policy step in which a user can define a whitelist of applications allowed to access the disk device.

9. Execution platform for controlling access for a disk device connected to the execution platform,
wherein the disk device comprises a first region, in which a unique disk label is stored and which is not encrypted, and second region, which includes data and file information and which is encrypted,
wherein a cipher agent is running on the execution platform and carries out the following steps in case an opening of the disk device is requested,
reading the unique disk label stored in the first region,
retrieving a protection policy for the disk device based on the unique disk label and
handling the further access to the disk device based on the protection policy.
